(19) United States
(12) Patent Application Publication
(10) Pub. No.: US 2023/0264644 A1
(43) Pub. Date: Aug. 24, 2023

(54) HEAD PROTECTION AIRBAG DEVICE

(71) Applicant: TOYODA GOSEI CO., LTD., Kiyosu-shi (JP)

(72) Inventor: Jun SATO, Aichi-ken (JP)

(21) Appl. No.: 18/169,965

(22) Filed: Feb. 16, 2023

(30) Foreign Application Priority Data
Feb. 18, 2022 (JP) 2022-023920

(51) Int. Cl. B60R 21/232; B60R 21/213; B60R 21/231

(52) U.S. Cl. CPC B60R 21/232; B60R 21/213; B60R 21/23138

(57) ABSTRACT

A head protection airbag device includes: an airbag that is folded and housed on an upper edge side of a window on a vehicle inner side of a vehicle, and that is deployed and inflated downward to cover the vehicle inner side of the window when an inflation gas from an inflator flows in. The airbag includes a window shielding inflatable portion that covers the vehicle inner side of the window when inflation is completed. A folded shape of the window shielding inflatable portion includes: an inward roll-folded portion that is roll-folded toward the vehicle inner side such that a lower edge side of the airbag flatly deployed approaches an upper edge side; and an outward roll-folded portion that is roll-folded toward an vehicle outer side such that the inward roll-folded portion is disposed on a center side and is close to the upper edge side of the airbag.

### CROSS-REFERENCE TO RELATED APPLICATIONS

This application is based upon and claims the benefit of priority from prior Japanese patent application No. 2022-023920 filed on Feb. 18, 2022, the entire contents of which are incorporated herein by reference.

### TECHNICAL FIELD

The present disclosure relates to a head protection airbag device including an airbag that is folded and housed on an upper edge side of a window on a vehicle inner side of a vehicle, and that is deployed and inflated downward when an inflation gas flows in to cover the vehicle inner side of the window.

### BACKGROUND ART

In the related art, in such a head protection airbag device, the airbag is folded by outward roll folding in which a lower edge side in a flatly deployed state is roll-folded so as to approach an upper edge side on a vehicle outer side wall portion side of the airbag (for example, refer to JP-A-2013-71542). In this head protection airbag device, when the airbag is deployed downward from the upper edge side of the window during operation, the airbag is deployed and inflated close to the window by releasing folding of the outward roll folding, so that the airbag can smoothly enter between an occupant and the window even when the occupant is close to the window.

However, in the head protection airbag device of the related art, in a case where the airbag is deployed and inflated downward from the upper edge side of the window in a state where a lower frame part of the window is strongly pushed toward the vehicle inner side due to a side collision of the vehicle, the airbag may ride on the lower frame part of the window and not able to cover the vehicle inner side of the lower frame part, and a smooth deployed state toward the vehicle inner side may not be secured.

### SUMMARY

The present disclosure solves the above-described problem, and an object thereof is to provide a head protection airbag device capable of stably deploying and inflating an airbag on a vehicle inner side when the airbag is deployed and inflated.

According to an aspect of the present disclosure, there is provided a head protection airbag device including: an airbag that is folded and housed on an upper edge side of a window on a vehicle inner side of a vehicle along a front-rear direction, and that is deployed and inflated downward to cover the vehicle inner side of the window when an inflation gas from an inflator flows in, in which the airbag includes a window shielding inflatable portion that covers the vehicle inner side of the window when inflation is completed, and in which a folded shape of the window shielding inflatable portion of the airbag includes: an inward roll-folded portion that is roll-folded toward the vehicle inner side such that a lower edge side of the airbag flatly deployed approaches an upper edge side; and an outward roll-folded portion that is roll-folded toward an vehicle outer side such that the inward roll-folded portion is disposed on a center side and is close to the upper edge side of the airbag.

In the head protection airbag device according to the present disclosure, when the airbag folded and housed on the upper edge side of the window is deployed and inflated, the window shielding inflatable portion is provided with the outward roll-folded portion on the outer peripheral side of the inward roll-folded portion on the center side of the roll folding. At the time of releasing the folding of the outward roll-folded portion, the outward roll-folded portion is deployed and inflated along the window, and the folding thereof is released. Thereafter, the folding of the inward roll-folded portion is released, and the window shielding inflatable portion is deployed over the entire region up to the lower edge, and the inflation is completed. At this time, at the beginning of deployment and inflation, since the folding of outward roll-folded portion is released, the outward roll-folded portion is deployed toward the vehicle outer side and deployed and inflated along the window, and thereafter, when the folding of the inward roll-folded portion is released, the inward roll-folded portion is deployed toward the vehicle inner side. That is, even when the airbag is deployed toward the vehicle outer side at the beginning of deployment and inflation, the lower edge side of the airbag eventually moves toward the vehicle inner side as the folding of the inward roll-folded portion is released, so that the entire airbag can be completely deployed and inflated on the vehicle inner side.

Therefore, in the head protection airbag device according to the present disclosure, the airbag at the time of deployment and inflation can be stably deployed and inflated on the vehicle inner side.

In the head protection airbag device according to the present disclosure, the window shielding inflatable portion of the airbag when the inflation is completed includes: a shielding main body portion disposed on the vehicle inner side of the window; and a lower frame side inflatable portion extending downward from the shielding main body portion and configured to cover the vehicle inner side of a lower frame part of the window, and the inward roll-folded portion of the airbag is preferably configured such that the lower frame side inflatable portion is provided, and folding is released on the vehicle inner side of an upper portion side of the lower frame part at a time of deployment and inflation.

In such a configuration, when the airbag is deployed and inflated, the shielding main body portion side of the window shielding inflatable portion is deployed while facing the vehicle outer side by release of the folding of the outward roll-folded portion, and the inward roll-folded portion attempts to release the folding. At this time, even when the lower frame part of the window is pressed toward the vehicle inner side and the lower edge side of the airbag tries to ride on the lower frame part, the lower edge side of the airbag is the inward roll-folded portion, and when the folding is released, the lower edge side is guided while being in contact with the lower frame part itself, and the folding is released toward the vehicle inner side. As a result, at the time of deployment and inflation, the airbag can be stably deployed and inflated completely on the vehicle inner side.

In this case, it is preferable that the airbag includes a temporary holding device that allows the inward roll-folded portion at the time of deployment and inflation to be disposed on the vehicle inner side of an upper end of the lower frame part when folding of the outward roll-folded portion is released without inhibiting releasing of folding.

In such a configuration, the inward roll-folded portion before the folding is released can be stably disposed on the vehicle inner side of the upper end of the lower frame part of the window by the temporary holding device, so that when the folding of the inward roll-folded portion is released thereafter, the lower frame side inflatable portion can be stably deployed and inflated on the vehicle inner side of the lower frame part of the window.

The temporary holding device may be formed of a connecting member configured to be disconnected when folding of the inward roll-folded portion is released, and having a lower connection portion connected to the inward roll-folded portion such that the inward roll-folded portion at a time of releasing folding of the outward roll-folded portion is pulled toward a vehicle inner side wall portion side of the shielding main body portion when the folding of the outward roll-folded portion is released, and an upper connection portion connected to a vehicle inner side portion side of the shielding main body portion above the lower connection portion.

That is, in such a configuration, when the inward roll-folded portion attempts to release the folding, the connecting member can pull the inward roll-folded portion to which the lower connection portion is connected toward the vehicle inner side so as to rotate the inward roll-folded portion around the upper connection portion in a state where the upper connection portion is connected to the vehicle inner side portion side of the shielding main body portion. Therefore, immediately before the folding of the inward roll-folded portion is released, the inward roll-folded portion is stably disposed on the vehicle inner side on the upper portion side of the lower frame part of the window. Then, when the connecting member releases a connection state between the inward roll-folded portion and the vehicle inner side portion of the shielding main body portion at the start of the subsequent folding release, the lower frame side inflatable portion constituting the inward roll-folded portion is smoothly deployed to the vehicle inner side of the lower frame part of the window while the folding of the inward roll-folded portion is released, so that the inflation is completed.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a schematic front view of a head protection airbag device according to an embodiment of the present disclosure as viewed from a vehicle inner side;

FIG. 2 is a front view showing a state in which an airbag used in the embodiment is flatly deployed;

FIG. 3 is a schematic sectional view illustrating a folding process of the airbag according to the embodiment.

FIG. 4 is a schematic front view illustrating the folding process of the airbag according to the embodiment;

FIG. 5 is a schematic longitudinal sectional view of the airbag when the head protection airbag device according to the embodiment is activated;

FIG. 6 is a schematic longitudinal sectional view of the airbag when the head protection airbag device according to the embodiment is activated, and shows a state after FIG. 5; and

FIG. 7 is a view illustrating a modification of a temporary holding device of the head protection airbag device according to the embodiment.

### DESCRIPTION OF EMBODIMENTS

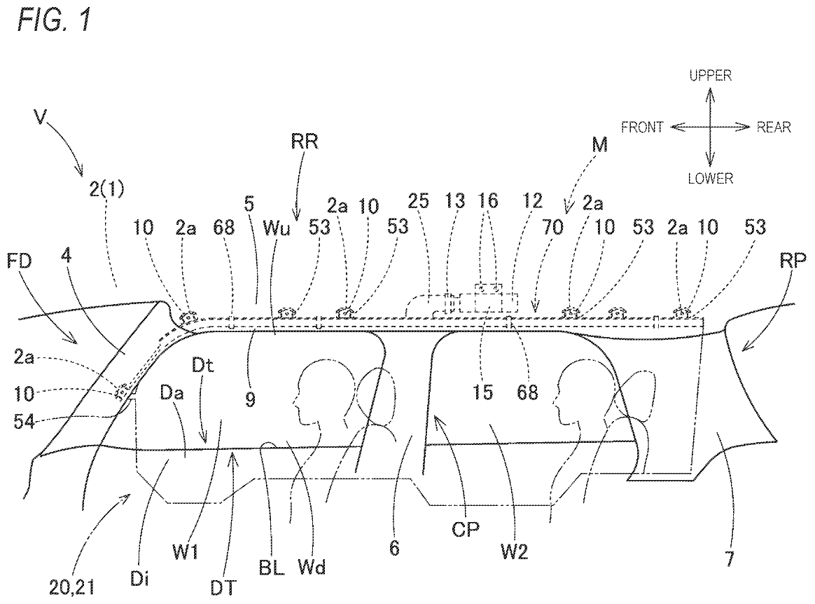

Hereinafter, an embodiment of the present disclosure will be described with reference to the drawings. As shown in FIG. 1, a head protection airbag device M according to the embodiment is mounted on a vehicle V including two windows (side windows) W (W1, W2), and is mounted on an upper edge Wu side of the windows W (1, 2) on a vehicle inner side.

The head protection airbag device M includes an airbag 20, an inflator 12, attachment tools 10, an attachment bracket 15, and an airbag cover 9. On the upper edge Wu side of the window W (1, 2) on the vehicle inner side of the vehicle V, the airbag 20 is folded and housed from a lower edge side of a front pillar portion FP to a region above a rear pillar portion RP via a lower edge side of a roof side rail portion RR along a front-rear direction.

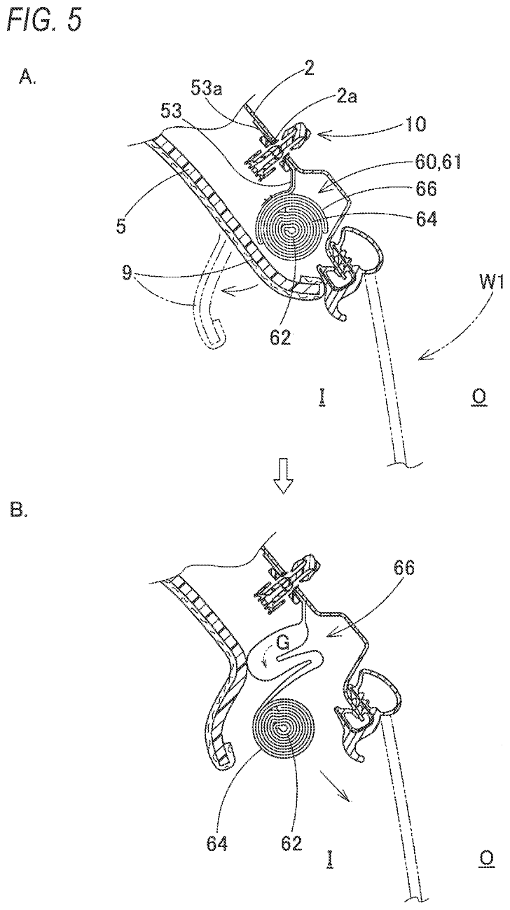

The airbag cover 9 includes a lower edge of a front pillar garnish 4 provided at the front pillar portion FP and a lower edge of a roof head lining 5 provided at the roof side rail portion RR. The front pillar garnish 4 and the roof head lining 5 are formed of a synthetic resin, and are attached and fixed to the vehicle inner side of an inner panel 2 on a body 1 (a vehicle body) side of the vehicle V at the front pillar portion FP and the roof side rail portion RR, respectively. The airbag cover 9 covers an vehicle inner side I of the airbag 20 that is folded and housed (see FIG. 5), and can be pushed by the airbag 20 and opened to the vehicle inner side I so that the airbag 20 can protrude downward on the vehicle inner side when being deployed and inflated.

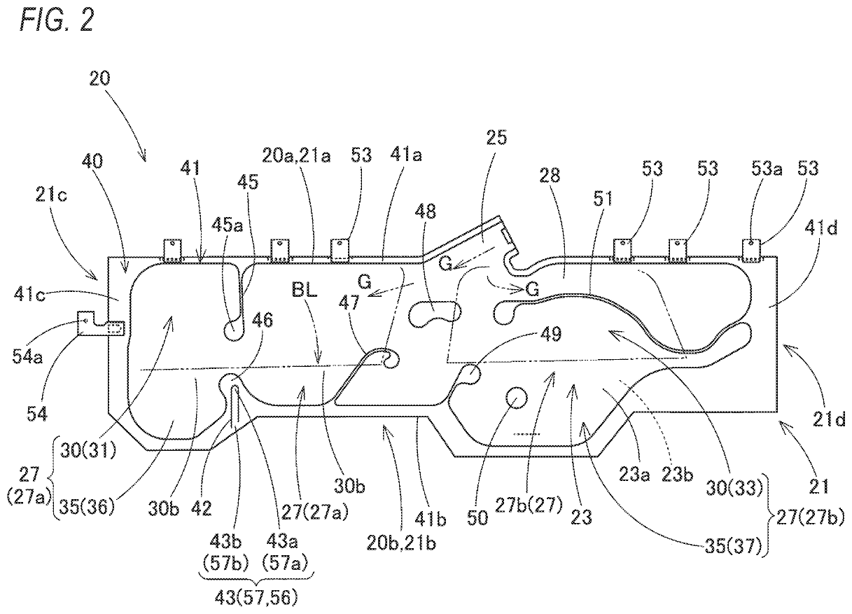

The inflator 12 supplies an inflation gas G (see FIGS. 2 and 5) to the airbag 20, and is of a substantially columnar cylinder type, and a gas ejection port (not shown) capable of ejecting an inflation gas is formed on a distal end side of the inflator 12. The distal end side of the inflator 12 including a vicinity of the gas ejection port is inserted into a connection port portion of the airbag 20 to be described later. The inflator 12 is connected to the airbag 20 using a clamp 13 provided on an outer peripheral side of the connection port portion 25. Further, the inflator 12 is attached to a position above the window W2 of the inner panel 2 by fixing the attachment bracket 15 for holding the inflator 12 to the inner panel 2 on the body 1 side with bolts 16. Further, the inflator 12 is electrically connected to a control device (not shown) of the vehicle V via a lead wire (not shown), and is configured to operate upon input of an operation signal from the control device when the control device detects a side collision, an oblique collision, a rollover, or the like of the vehicle V.

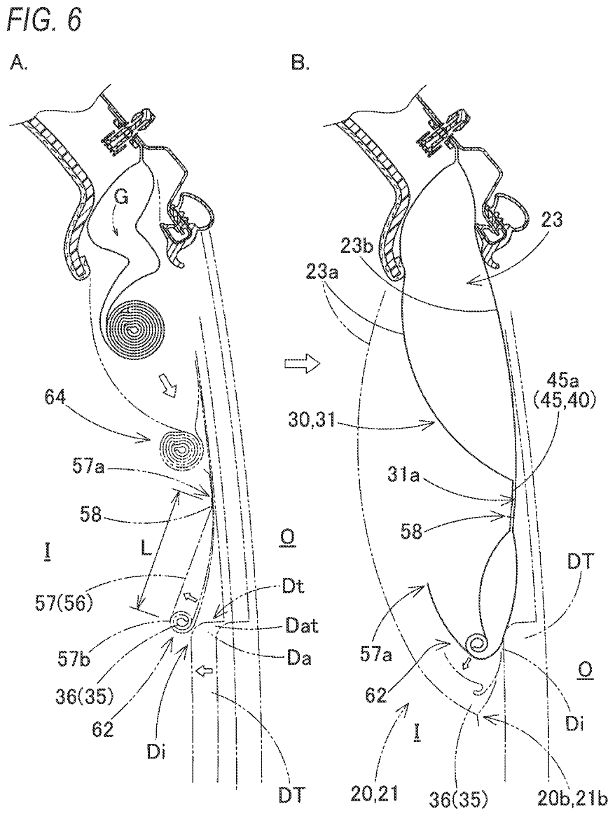

As shown in FIGS. 5 and 6, each attachment tool 10 is used to attach an attachment piece 53 and a tension belt 54 of the airbag 20 to the inner panel 2. In the case of the embodiment, each attachment tool 10 is a clip type made of a synthetic resin, and is inserted into an attachment hole 2a of the inner panel 2 and is locked to a peripheral edge of the attachment hole 2a.

The tension belt 54 is attached to a front edge 21c of the airbag 20, and a front end side of the tension belt 54 is attached to the inner panel 2 of the front pillar portion FP (see FIGS. 1 and 2).

As shown in FIG. 2, the airbag 20 includes a bag main body 21, attachment pieces 53, and the tension belt 54.

The bag main body 21 is configured to allow the inflation gas G from the inflator 12 to flow into an interior of the bag main body 21, to deploy from a folded state, and to cover the vehicle inner side I of the windows W (W1, W2) and pillar garnishes 6, 7 of a center pillar portion CP and the rear pillar portion RP. An outer shape of the bag main body 21 is a substantially rectangular plate shape with a longitudinal direction substantially along the front-rear direction so that the bag main body 21 can cover the vehicle inner side I from the window W1 through the center pillar portion CP and the window W2 to a front side of the rear pillar portion RP when inflation is completed (see a two-dot chain line in FIG. 1). In the embodiment, the bag main body 21 is produced by bag weaving using polyamide yarn, polyester yarn, or the like.

Further, as shown in FIGS. 2 and 6, the bag main body 21 includes a gas inflow portion 23 that inflates by introducing the inflation gas G inside so as to separate a vehicle inner side wall portion 23a located on the vehicle inner side and a vehicle outer side wall portion 23b located on a vehicle outer side O when inflation is completed, and a non-inflowing portion 40 that connects the vehicle inner side wall portion 23a and the vehicle outer side wall portion 23b to prevent the inflation gas from flowing in.

The gas inflow portion 23 includes the cylindrical connection port portion 25 which is disposed on the upper edge side and is connected to the inflator 12, and a window shielding inflatable portion 27 which is inflated by causing the inflation gas G to flow in from the connection port portion 25 so as to cover the vehicle inner side of the windows W (W1, W2). In the embodiment, the connection port portion 25 is provided near a middle of the bag main body 21 in the front-rear direction and extends obliquely rearward from an upper edge 21a side.

The window shielding inflatable portion 27 is inflated such that a front portion 27a covers the vehicle inner side I of the window W1 so as to be able to protect an occupant in a front seat, and a rear portion 27b covers the vehicle inner side I of the window W2 so as to be able to protect an occupant in a rear seat.

Further, the window shielding inflatable portion 27 includes a shielding main body portion 30 disposed on the vehicle inner side I of the windows W1 and W2, and a lower frame side inflatable portion 35 extending downward from the shielding main body portion 30 and capable of covering the vehicle inner side I (vehicle inner side surface Di) in an upper portion Da of a door trim DT as a lower frame part of the windows W1 and W2. The window shielding inflatable portion 27 is provided with a gas conducting portion 28 disposed in a region on an upper portion side of the shielding main body portion 30 so that the inflation gas G flowing from the connection port portion 25 flows to the front and rear of the shielding main body portion 30.

The shielding main body portion 30 includes a front shielding main body portion 31 capable of covering the vehicle inner side I of the window W1, and a rear shielding main body portion 33 capable of covering the vehicle inner side of the window W2. The front shielding main body portion 31 connects a front side portion 36 of the lower frame side inflatable portion to the lower side, and the rear shielding main body portion 33 connects a rear side portion 37 of the lower frame side inflatable portion 35 to the lower side.

In the window shielding inflatable portion 27 of the airbag 20 of the embodiment, when inflation is completed, a lower edge 30b side of the shielding main body portion 30 and the lower frame side inflatable portion 35 are disposed on an upper edge of the door trim DT on a lower edge Wd side of the windows W1 and W2, that is, below a belt line BL.

The non-inflowing portion 40 includes a peripheral edge portion 41 constituting an outer peripheral edge of the gas inflow portion 23, and closing portions 45, 46, 47, 48, 49, and 50 disposed in a region of the window shielding inflatable portion 27.

The closing portion 45 is disposed in the front shielding main body portion 31 so as to extend downward from an upper edge 41a of the peripheral edge portion 41, and the closing portion 46 is disposed below the closing portion 45 so as to extend upward from a lower edge 41b of the peripheral edge portion 41. The closing portions 47 and 49 are arranged side by side in the front-rear direction behind the closing portion 46, and are disposed to extend upward from the lower edge 41b. The closing portion 48 is disposed above and between the closing portions 46 and 47 so as to be separated from the peripheral edge portion 41. The closing portion 50 has a substantially circular shape, and is disposed behind the closing portion 49 and separated from the lower edge 41b. The closing portion 51 is disposed so as to extend forward from a rear edge 41d of the peripheral edge portion 41 to the vicinity of the lower side of the connection port portion 25.

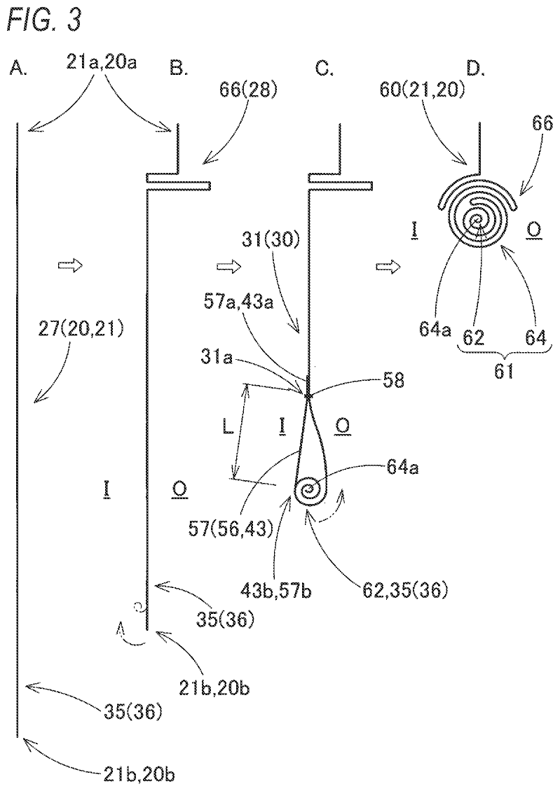

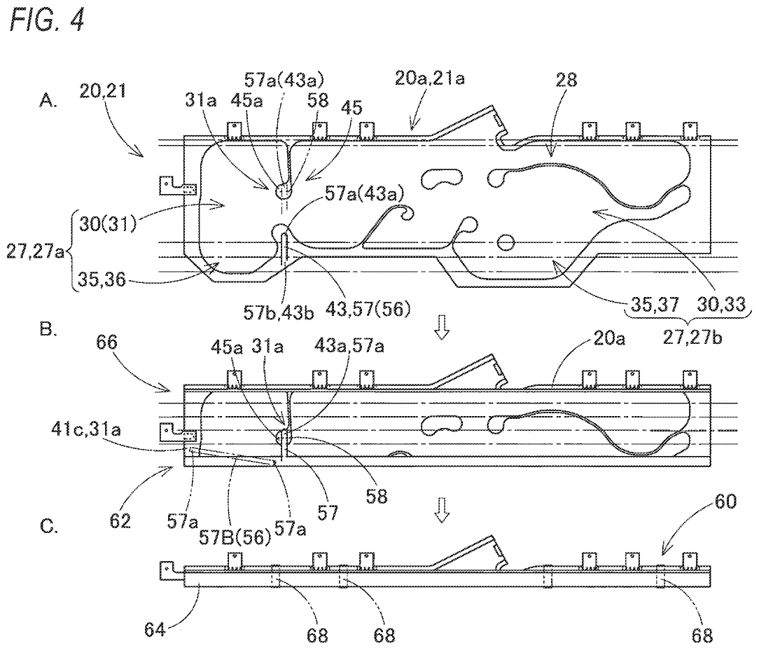

In the embodiment, the closing portion 46 is provided with an inverted U-shaped slit 42 and a tongue piece 43 forming a connecting member 57. The connecting member 57 formed of the tongue piece 43 is connected, with a distal end 43a of the tongue piece 43 as an upper connection portion 57a, to a lower end 45a of the closing portion 45 on a vehicle inner side portion 31a side, which is the vehicle inner side I of the front shielding main body portion 31 (see Section C of FIG. 3 and Section B of FIG. 4). The connection is performed by sewing using a breakable sewing thread 58. Further, a lower connection portion 57b of the connecting member 57 is formed of a base portion 43b itself of the tongue piece 43, and is disposed so as to be integrally formed with the lower edge 41b of the peripheral edge portion 41.

The connecting member 57 formed of the tongue piece 43 constitutes a temporary holding device 56 of an inward roll-folded portion 62 to be described later when the airbag 20 is deployed and inflated. The temporary holding device 56 allows the inward roll-folded portion 62 to be disposed on the vehicle inner side I of an upper end surface Dt of the door trim DT as the lower frame part when folding of an outward roll-folded portion 64 to be described later is released without inhibiting the folding of the inward roll-folded portion 62 from being released. In the embodiment, the temporary holding device 56 is formed of the connecting member 57, and the connecting member 57 is disposed such that the connection between the inward roll-folded portion 62 and the vehicle inner side portion 31a can be disconnected when the folding of the inward roll-folded portion 62 is released. In the embodiment, the connection between the inward roll-folded portion 62 and the vehicle inner side portion 31a is disconnected by the breakage of the sewing thread 58. Further, a length dimension L of the connecting member 57 is set to a dimension that allows the inward roll-folded portion 62 to be pulled toward the vehicle inner side I of the upper end surface Dt of the door trim DT when the folding of the outward roll-folded portion 64 is released (see Sections A and B of FIG. 6).

The attachment pieces 53 are joined to an upper edge 20a side of the airbag 20 (the upper edge 21a of the bag main body 21) by sewing and are provided at six positions along the front-rear direction. Each of the attachment pieces 53 has an attachment hole 53a, through which the attachment tool 10 passes, on a distal end side.

The tension belt 54 is attached to the front edge 21c of the bag main body 21, and has an attachment hole 54a through which the attachment tool 10 passes at a distal end (front end).

Further, the airbag 20 is housed on the upper edge Wu side of the window W as a completely folded body 60 folded such that a lower edge 21b approaches the upper edge 21a of the bag main body 21 in a flatly deployed state in which the vehicle inner side wall portion 23a and the vehicle outer side wall portion 23b are overlapped.

In a folding process of the completely folded body 60, first, as shown in Sections A and B of FIG. 3 and Sections A and B of FIG. 4, a bellows-folded portion 66 is formed in the gas conducting portion 28 on the upper edge 20a side of the flattened airbag 20 (the upper edge 21a side of the bag main body 21). Next, as shown in Sections B and C of FIG. 3 and Section B of FIG. 4, the inward roll-folded portion 62 is formed by roll-folding toward the vehicle inner side I so that a lower edge 20b (21b) side approaches the upper edge 20a side. The inward roll-folded portion 62 includes a portion of the lower frame side inflatable portion 35 (specifically, the lower frame side inflatable portion 35 and the lower edge 30b of the shielding main body portion 30). In the front side portion 36, the connecting member 57 formed of the tongue piece 43 is pulled out, and the distal end 43a is connected to the lower end 45a of the closing portion 45 on the vehicle inner side portion 31a side of the front shielding main body portion 31 by sewing using the sewing thread 58.

Next, as shown in Sections C and D of FIG. 3 and Sections B and C of FIG. 4, when the outward roll-folded portion 64 that is roll-folded toward the vehicle outer side O is formed so as to be close to the upper edge 20a side of the airbag 20 while the inward roll-folded portion 62 is disposed on a center 64a side, the completely folded body 60 of a folded shape 61 in which the inward roll-folded portion 62 is disposed on the center 64a side of the outward roll-folded portion 64 can be formed. After the completely folded body 60 is formed, the completely folded body 60 is wrapped with a breakable wrapping material 68 so as to prevent folding collapse.

Then, the attachment tools 10 are attached to the attachment pieces 53 or the tension belt 54, and the inflator 12 to which the attachment bracket 15 is attached is inserted into the connection port portion 25 and connected to the connection port portion 25 by using the clamp 13, whereby an airbag assembly 70 can be formed. Thereafter, each attachment tool 10 is attached by being inserted into the corresponding attachment hole 2a of the inner panel 2, and the attachment bracket 15 that holds the inflator 2 is fixed to a predetermined portion of the inner panel 2 with the bolts 16, and a lead wire (not shown) extending from a control device for operating the inflator is connected to the inflator 12. When the front pillar garnish 4 and the roof head lining 5 are attached to the inner panel 2 on the body 1 side, and the pillar garnishes 6 and 7 are attached to the inner panel 2 on the body 1 side, the head protection airbag device M can be mounted on the vehicle V.

After the head protection airbag device M according to the embodiment is mounted on the vehicle V, if the inflator 12 is operated in response to an operation signal from the control device at a time of a side collision, an oblique collision, or a rollover of the vehicle V, the inflation gas G (see FIG. 2) ejected from the inflator 12 flows into the bag main body 21, and the inflated bag main body 21 breaks the wrapping material 68. Further, the bag main body 21 pushes and opens the airbag cover 9 including the lower edges of the front pillar garnish 4 and the roof head lining 5, protrudes downward, and inflates greatly so as to cover the vehicle inner side I of the windows W1, W2, the center pillar portion CP, and the rear pillar portion RP as shown by the two-dot chain line in FIG. 1 and FIGS. 5 and 6.

At this time, in the head protection airbag device M according to the embodiment, the window shielding inflatable portion 27 has the folded shape 61 in which the outward roll-folded portion 64 is disposed on the outer peripheral side of the inward roll-folded portion 62 on the center 64a side of the roll folding. At the time of releasing the folding of the outward roll-folded portion 64, as shown in Sections A and B of FIG. 5 and Sections A and B of FIG. 6, the outward roll-folded portion 64 is deployed and inflated along the window W1, and the folding thereof is released. Thereafter, the folding of the inward roll-folded portion 62 is released, and the window shielding inflatable portion 27 is deployed over the entire region up to the lower edge 20b, and the inflation is completed. At this time, at the beginning of deployment and inflation, as shown in Sections A and B of FIG. 5 and Section A of FIG. 6, since the folding of outward roll-folded portion 64 is released, the outward roll-folded portion 64 is deployed toward the vehicle outer side O and deployed and inflated along the window W1, and thereafter, when the folding of the inward roll-folded portion 62 is released, the inward roll-folded portion 62 is deployed toward the vehicle inner side I. That is, even when the airbag is deployed toward the vehicle outer side O at the beginning of deployment and inflation, the lower edge 20b side of the airbag 20 eventually moves toward the vehicle inner side I as the folding of the inward roll-folded portion 62 is released, so that the entire airbag 20 can be completely deployed and inflated on the vehicle inner side I. Although not shown, the deployment and inflation of the airbag 20 on the vehicle inner side I can be completed also at the portion of the window W2 in the same manner.

Therefore, in the head protection airbag device M according to the embodiment, the airbag 20 at the time of deployment and inflation can be stably deployed and inflated on the vehicle inner side I.

In the head protection airbag device M according to the embodiment, the window shielding inflatable portion 27 of the airbag 20 when the inflation is completed includes the shielding main body portion 30 disposed on the vehicle inner side I of the windows W1 and W2, and the lower frame side inflatable portion 35 extending downward from the shielding main body portion 30 and capable of covering the vehicle inner side I of the door trim DT as the lower frame part of the windows W1 and W2. Further, the inward roll-folded portion 62 of the airbag 20 is configured such that the lower frame side inflatable portion 35 is disposed, and the folding is released at the vehicle inner side surface Di on the upper portion Da side of the door trim DT at the time of deployment and inflation.

Therefore, in the embodiment, when the airbag 20 is deployed and inflated, the shielding main body portion 30 side of the window shielding inflatable portion 27 is deployed while facing the vehicle outer side O by release of the folding of the outward roll-folded portion 64, and the inward roll-folded portion 62 attempts to release the folding. At this time, for example, even when the door trim DT of the window W1 is pressed toward the vehicle inner side I as shown in Section A of FIG. 6 and the front side portion 36 of the lower frame side inflatable portion 35 on the lower edge 20b side of the airbag 20 tries to ride on the door trim DT, the lower edge 20b side of the airbag 20 is the inward roll-folded portion 62 as shown in Section B of FIG. 6, and when the folding is released, the lower edge 20b side of the airbag 20 is guided by the door trim DT itself, and the folding is released toward the vehicle inner side I. As a result, at the time of deployment and inflation, the airbag 20 can be stably deployed and inflated completely on the vehicle inner side I.

Regarding to rear portion 27b of the window shielding inflatable portion 27 that covers the window W2, although not shown, even if the door trim DT of the window W2 moves to the vehicle inner side, the rear portion 27b of the window shielding inflatable portion 27 is guided to the vehicle inner side I of the center pillar portion CP, and the rear side portion 37 of the lower frame side inflatable portion 35 can be deployed and inflated completely on the vehicle inner side I of the door trim DT.

Further, in the embodiment, the airbag 20 includes the temporary holding device 56 that allows the inward roll-folded portion 62 at the time of deployment and inflation to be disposed on the vehicle inner side I (vehicle inner side surface Di) of an upper end Dat of the door trim DT as the lower frame part when the folding the outward roll-folded portion 64 is released without inhibiting the folding of the inward roll-folded portion 62 from being released.

Therefore, in the embodiment, since the inward roll-folded portion 62 before the folding is released can be stably disposed on the vehicle inner side surface Di of the upper end Dat of the door trim DT of the window W1 by the temporary holding device 56, as shown in A and Section B of FIG. 6, when the folding of the inward roll-folded portion 62 is released thereafter, the front side portion 36 of the lower frame side inflatable portion 35 can be stably deployed and inflated on the vehicle inner side I of the door trim DT of the window W1.

In the embodiment, the connecting member 57 is used as the temporary holding device 56. The connecting member 57 can be disconnected when the folding of the inward roll-folded portion 62 is released, and includes the lower connection portion 57b connected to the inward roll-folded portion 62 such that the inward roll-folded portion 62 at the time of releasing the folding of the outward roll-folded portion 64 can be pulled toward the vehicle inner side wall portion 23a side of the front shielding main body portion 31 of the shielding main body portion 30 when the folding of the outward roll-folded portion 64 is released, and an upper connection portion 57a connected to the vehicle inner side portion 31a side of the front shielding main body portion 31 of the shielding main body portion 30 above the lower connection portion 57b.

Therefore, in the embodiment, when the inward roll-folded portion 62 attempts to release the folding, as shown in Sections A and B of FIG. 6, the connecting member 57 can pull the inward roll-folded portion 62 to which the lower connection portion 57b is connected toward the vehicle inner side I so as to rotate the inward roll-folded portion 62 around the upper connection portion 57a in a state where the upper connection portion 57a is connected to the vehicle inner side portion 31a side of the shielding main body portion 30. Therefore, immediately before the folding of the inward roll-folded portion 62 is released, the inward roll-folded portion 62 is stably disposed on the vehicle inner side surface Di on the upper portion Da side of the door trim DT of the window W1. Then, when the sewing thread 58 is broken at the start of the subsequent folding release, and the connecting member 57 releases a connected state between the inward roll-folded portion 62 and the vehicle inner side portion 31a side of the shielding main body portion 30, the front side portion 36 of the lower frame side inflatable portion 35 constituting the inward roll-folded portion 62 is smoothly deployed to the vehicle inner side I of the door trim DT of the window W1 while the folding of the inward roll-folded portion 62 is released, so that the inflation is completed.

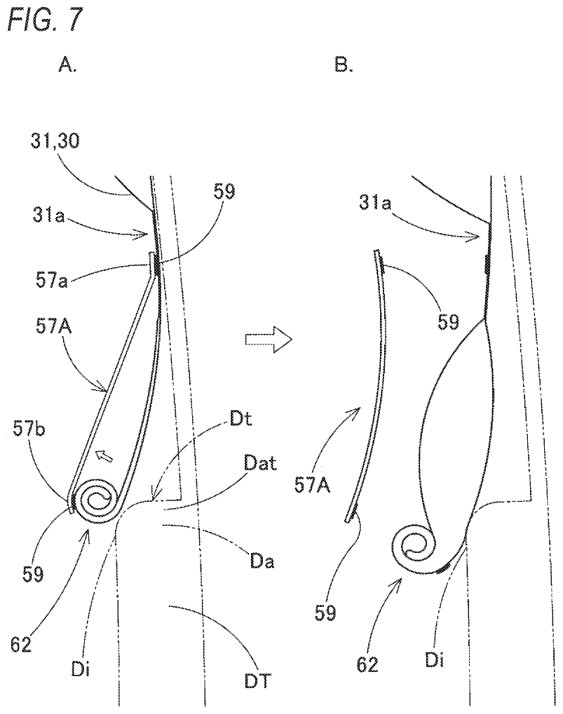

In the embodiment, as the temporary holding device 56 for holding the inward roll-folded portion 62 so as to pull the inward roll-folded portion 62 toward the vehicle inner side I immediately before the folding is released, the connecting member 57 for connecting the inward roll-folded portion 62 and the vehicle inner side portion 31a side of the shielding main body portion 30 by using sewing is exemplified. Alternatively, as shown in FIG. 7, a tape-shaped connecting member 57A using an adhesive 59 may be used. By using the connecting member 57A, when the inward roll-folded portion 62 attempts to release the folding, the connecting member 57 can also pull the inward roll-folded portion 62 connected to the lower connection portion 57b to the vehicle inner side I in a state where the upper connection portion 57a is connected to the vehicle inner side portion 31a side of the shielding main body portion 30.

Further, in the embodiment, the connecting member 57 as the temporary holding device 56 is disposed on the front side portion 36 side of the lower frame side inflatable portion 35, which is the front portion 27a side of the window shielding inflatable portion 27. Alternatively, the connecting member 57 may also be disposed on the rear side portion 37 side of the lower frame side inflatable portion 35.

Further, in the embodiment, the connecting member 57 as the temporary holding device 56 is configured such that the lower connection portion 57b side is connected to the inward roll-folded portion 62, and the upper connection portion 57a side is connected to the lower end 45a of the closing portion 45 which is the vehicle inner side portion 31a side directly above the lower connection portion 57b. Alternatively, as shown by the two-dot chain line in Section B of FIG. 4, a connecting member 57B may be configured such that the lower connection portion 57b side is connected to the inward roll-folded portion 62, and the upper connection portion 57a side is connected to a front edge 41c of the peripheral edge portion 41 on the vehicle inner side portion 31a side of the shielding main body portion 30. In the case of the shown example, the upper and lower connection portions 57a and 57b are respectively connected to the inward roll-folded portion 62 and to the front edge 41c on the vehicle inner side portion 31a side using an adhesive, and at least one of the connection portions 57a and 57b is peeled off to release the connection so that the folding of the inward roll-folded portion 62 is not inhibited from being released when a tensile force acts on the connecting member 57B at the time of releasing the folding of the inward roll-folded portion 62.

Further, as the connecting members 57, 57A, and 57B, at a portion between the connection portions 57a and 57b on both sides, there may be provided a slit or a breakable portion whose width dimension is narrowed and strength is reduced so as to break and further disconnect the connection with the inward roll-folded portion 62 and with the vehicle inner side portion 31a side when the folding of the inward roll-folded portion 62 is started to release.

Further, the upper connection portion and the lower connection portion of the connecting member may be provided at a portion of the peripheral edge portion 41 or a portion of the closing portion as the non-inflowing portion 40, or may be disposed in a region of the gas inflow portion 23 as long as leakage of the inflation gas does not occur.

1. A head protection airbag device comprising:
an airbag that is folded and housed on an upper edge side of a window on a vehicle inner side of a vehicle along a front-rear direction, and that is deployed and inflated downward to cover the vehicle inner side of the window when an inflation gas from an inflator flows in,
wherein the airbag includes a window shielding inflatable portion that covers the vehicle inner side of the window when inflation is completed, and
wherein a folded shape of the window shielding inflatable portion of the airbag includes:
an inward roll-folded portion that is roll-folded toward the vehicle inner side such that a lower edge side of the airbag flatly deployed approaches an upper edge side; and
an outward roll-folded portion that is roll-folded toward a vehicle outer side such that the inward roll-folded portion is disposed on a center side and is close to the upper edge side of the airbag.

2. The head protection airbag device according to claim 1,
wherein the window shielding inflatable portion of the airbag when the inflation is completed includes:
a shielding main body portion disposed on the vehicle inner side of the window; and
a lower frame side inflatable portion extending downward from the shielding main body portion and configured to cover the vehicle inner side of a lower frame part of the window, and
wherein the inward roll-folded portion of the airbag is configured such that the lower frame side inflatable portion is provided, and folding is released on the vehicle inner side of an upper portion side of the lower frame part at a time of deployment and inflation.

3. The head protection airbag device according to claim 2,
wherein the airbag includes a temporary holding device that allows the inward roll-folded portion at the time of deployment and inflation to be disposed on the vehicle inner side of an upper end of the lower frame part when folding of the outward roll-folded portion is released without inhibiting releasing of folding.

4. The head protection airbag device according to claim 3,
wherein the temporary holding device is formed of a connecting member configured to be disconnected when folding of the inward roll-folded portion is released, and having a lower connection portion connected to the inward roll-folded portion such that the inward roll-folded portion at a time of releasing folding of the outward roll-folded portion is pulled toward a vehicle inner side wall portion side of the shielding main body portion when the folding of the outward roll-folded portion is released, and an upper connection portion connected to a vehicle inner side portion side of the shielding main body portion above the lower connection portion.
